(19) United States
(12) Patent Application Publication
(10) Pub. No.: US 2010/0107163 A1
(43) Pub. Date: Apr. 29, 2010

(54) MOVABLE VIRTUAL MACHINE IMAGE

(76) Inventor: Sanggyu Lee, Seoul (KR)

Correspondence Address: HAYNES AND BOONE, LLP;IP Section, 2323 Victory Avenue, Suite 700, Dallas, TX, 75219, US

(21) Appl. No.: 12/531,963

(22) PCT Filed: Mar. 20, 2008
(86) PCT No.: PCT/KR08/01567

§ 371 Date: Sep. 18, 2009

(30) Foreign Application Priority Data
Mar. 20, 2007 (KR) 10-2007-0027161

(51) Int. Cl. G06F 9/455; G06F 15/177; G06F 17/00; G06F 9/445

(52) U.S. Cl. 718/1; 713/2; 707/638; 717/177

(57) ABSTRACT

The present invention provides the movable virtual machine image using the OS level virtualization and the method for creating and utilizing the movable virtual machine image. The movable virtual machine image is independent of the hardware of PCs and easy to attach or detach from the OS, thereby presents easy and quick moving, distributing, sharing and initializing.

### TECHNICAL FIELD

The present invention relates to the virtual machine and more specifically, relates to movable personal computer environments created by the operating system level virtualization.

### BACKGROUND ART

Recently, personal computer technology has been developing very rapidly. A large number of people spend most of their days with PCs(Personal Computers). Various application products, such as word processors and spreadsheets, have ensured that they will use at least one PC in their work environment. The development of multimedia technology has spawned entertainment industries based on the PC's growth. In particular, the growing popularity of the Internet has played an important role in increasing human dependence on PCs. There is a growing tendency for modern people to depend on PCs in their everyday life. Some cannot imagine life without them.

The personal computing environment has been developing toward requiring less computer knowledge. In the 1980's, PCs required users to directly input commands defined by OS (operating systems) in order for the computer to work. Therefore a user who was not proficient in the command language could not utilize the computer. Furthermore, the user had to input specifications about each piece of hardware in order for the computer to recognize and operate the hardware.

In the 90's, GUI(Graphic User Interface) technology progressed so that a users could transmit commands to computers intuitively and visually. The OS were developed with the ability to identify hardware by itself so that the user required less knowledge about computers.

Today however, using PCs still requires a great deal of complicated knowledge. Ordinary people who are not familiar with some aspects of PCs, including the knowledge of operating systems and the installation and setting of applications, find them incomprehensible. This insures that only experts are able to PCs for some functions. Even though various kinds of technology, such as GUI are spreading, ordinary people still have difficulty installing and setting up applications. Additionally, all sorts of viruses and malignant programs make it difficult for people to use PCs easily.

If the PC is to be a more popular home appliance, in line with the television set or a refrigerator, computers need to be much easier to use than they currently are. In the case of a television set, all a user needs to master is the relatively simple remote control. Computer operation needs to be simplified so that they can be used just as easily.

PCs of today are faced with some new demands. Some of these demands include that PC environments should be moved easily and quickly, that software should be distributed easily, that a PC should be able to be shared through a new scheme while guaranteeing independent user environments, and that a PC should be able to be restored back to the initial status that the user had defined whenever the user wishes to do this.

The first issue is concerning the mobility of a PC environment. A PC has its own environment for each user; this is different from other home appliances. There is large a variety of hardware combinations. Furthermore, though the same hardware set and operating system are used, the desktop environment and the application programs can be diverse. This can result in the following problems.

For example, a person uses PCs at home and at the office. The PC at home and the PC at the office have different PC environments. Therefore, in order to make things easier, the user should make his PC environment at home the same as that at the office. He must install all required software and arrange all options for the best surroundings to aid in his work. In case the user has to use a computer on business trips, he has to adjust the PC environment at the destination of the business trip. In order to save the trouble, lap top computers are available. However, lap top computers are relatively expensive and heavy and this may be a large burden.

The second issue, concerning the distribution of software, a person who bought new software through downloading or physical media must install the software to his PC. While the process of installation is relatively simple, many people still have difficulty. Occasionally, when an internal or external problem occurs, the user has the inconvenience of having to reinstall the software.

In office surroundings, PC environments are generally grouped together. A group can be made to use the same software. Teams or positions may be the organizing factor for groups. A PC manager takes the responsibility of setting up the PC environment including all the required software for each group. However, dealing with the needs of each staff member one by one is very inefficient and takes a lot of time. If the PC environments are prepared in a storage device in advance and can be set up quickly, this will be advantageous whenever positions are rearranged, whenever a new employee enters the company or whenever the list of software required for business changes. Ultimately, everyone should be able to set up their own PC environment easily without the need of a PC manager.

The third issue is concerning the sharing of PCs. Suppose that two users share a PC. Each user wants their own PC environment so that it is optimal for their use. Sometimes, one user makes a mistake and exposes the PC to a computer virus. This can cause all users to suffer damages. This can results in the need to purchase another PC.

The final issue is in regard to the initializing of the PC environment. Modern PCs are constantly exposed to viruses and malignant codes. Consequently, a PC may be paralyzed as time goes by. Sometimes, the user happens to make a mistake himself and paralyzes his PC. In these cases, a professional PC analyzer must diagnose and treat the source of the trouble. Otherwise, the user has no choice but to format the hard disk and reinstall all required software and then set the desktop environment again. This is the chief obstacle to PC use. In order to utilize a PC easily and conveniently like other ordinary home appliances, users should be able to restore their PCs to the initial clean PC environment with only a couple of mouse-clicks and without professional support.

The more our dependency on PCs deepens, the more we need to use our own PC environments anywhere and at anytime. However, the only solution we have is to use additional hardware like lap top computers.

Currently, studies on virtual machines are in progress. The concept of the virtual machine was first introduced in 1960s to divide a mainframe multiple machines virtually in order for multiple users share the mainframe. However, as the price of microcomputers or PCs became lower, purchasing multiple PCs is more advantageous than sharing a mainframe. Therefore, the virtual machine technique was scarcely used in 1980s. However, in 1990s, using multiple small-capacity computers increased management and maintenance costs. Additionally, efficient use of computing resources has become an issue (for example, occasionally, server A uses the CPU 10%, whereas server B uses the CPU as much as 99%), and thus the virtualization technique attracts attention again. However, while a virtualization technique for efficiently managing resources of a large-scale server is in the mainstream, studies on a virtualization technique for a client system are insufficient as of yet.

The virtual machine of the present invention is used to provide mobility, distribution, sharing and initializing of PC environments with ease.

The methods of implementing virtual machines today are diverse. Some of the methods include hardware level virtualization, application level virtualization, operating system level virtualization, and the like. The following will explain some details and limitations of the current virtualization technique

Hardware Level Virtualization

There are two types of hardware level virtualization. One is full virtualization in which the CPU, memory, hard disk, Bios and the like are emulated in software. The other is the para-virtualization in which a device (CPU) supporting hardware level virtualization is utilized.

In the command set level virtualization method, the central processing unit, memory, chipset, bus, and a variety of peripherals (a network card, hard disk, floppy disk, and CD-ROM) are emulated in software to create a virtual machine. In the command set level virtualization method, all commands created in the virtual machine are processed by the software. This can cause many problems in performance, such as the degradation of processing speed.

In the para-virtualization method, the goal is not to emulate a command, similar to the command set level virtualization method, but to modify the source code or the binary code of OS to execute multiple OSes in a machine. In recent years, a CPU that allows multiple OSes to be executed in a single machine, without modifying the OSes, is being developed. In para-virtualization, since the command set is not reanalyzed in the software, processing speed is improved.

The hardware level virtualization provides a standard hardware set and the generated virtual machine image is the PC environment itself. Copying this image accompanies the copying of the installed OS together so that independence and mobility are guaranteed.

On the contrary, the hardware performance is equalized at a low level. For example, even if the real PC has an excellent 3D graphic card, an old-fashioned 2D graphic card operates the virtual PC, if the virtual machine provides a virtual graphic card by emulating the old-fashioned 2D graphic card. This means that a device that is not yet emulated, such as IEEE1394, cannot be used. However it is actually impossible to emulate all hardware devices launched up to now.

Furthermore, it is difficult to operate multiple virtual machines simultaneously, because the virtual machine created by hardware level virtualization needs all the resources required to operate an independent OS. For example, the window vista requires about 1GB RAMs. In order to operate three virtual machines and one real machine normally, at least 4G rams are required.

Furthermore the virtual machine image has a comparatively large size, because all hardware elements need to be emulated. The size of the virtual machine images generated by hardware level virtualization solutions up until today is in units of Giga bytes. This is very inefficient because such generated OS images require a size range from hundreds of mega bytes to tens of Giga bytes even in the case of the distribution of a small application such as notepad.exe.

Also, an additional OS license is needed since the virtual machine needs a new OS. This requires the user to purchase an additional OS.

The OS environment and all applications installed in the real machine cannot be shared with the virtual machine, because the virtual machine is fully independent of the real machine. There are solutions, for example, the P2V, by which an application within a real machine can be utilized in the virtual machine by duplication. However, it is still impossible to share an application program.

It is an advantage of hardware level virtualization that an independent OS can be installed in each virtual machine so that it is suitable to Server virtualization such as VPS (Virtual Private Server) and Server integration. It is also suitable to the development and testing of new software.

In conclusion, hardware level virtualization is suitable for server virtualization but not for desktop virtualization for commerce.

Application Level Virtualization

The application level virtualization method is a method that creates an application in the form of Bytecode. An example of this is the Java Virtual Machine developed by SunMicro Systems, which allows an application to be executed in a variety of heterogeneous hardware and software environments.

In the beginning, application level virtualization products were developed for the purpose of avoiding software collisions. For example, a windows environment includes executable files (.exe) and a shared library (.dll) The shared libraries are often manufactured by various companies and shared in various software. For example, the shared library, c:\windows\system32\msvcrt.dll is used in A′ program manufactured by A company and also used in B′ program manufactured by B company. The library, msvcrt.dll can have various versions for the same file name. While the A′ program uses msvcrt.dll Ver. 2.0.0.0 in the directory, c:\windows\syste32, the B′ program may be installed and msvcrt.dll Ver. 2.0.0.0 may be replaced by msvcrt.dll Ver. 1.0.0.0. This replacement causes a malfunction of the A′ program.

Such version collision problems can be avoided by application level virtualization. This allocates a unique file system storage area for each application so that shared libraries of the same file name are stored in the separated storage areas for each application.

Now, application level virtualization has been progressing to the application streaming technique. With this technique, application data for the application execution, like execution files, shared libraries, registries and the like, are stored in the server, not in the PC. When a user wants to execute the application, the needed data is recalled from the server dynamically. Therefore, the user can utilize the application without installing it in his PC

The advanced techniques of today store the application data in a USB drive. The user can also utilize the application without installation by connecting the USB drive to PC. This technique provides limited mobility of PC environment by enabling an application to be executed in any PC.

However, application level virtualization stores application data separately. This can resolve the problem of collision in the installation stage but not in the execution stage. For example, when two different anti-virus programs are used at the same time, they will clash with each other and cause abnormal errors. Such collisions in the execution stage cannot be resolved by application level virtualization.

In addition, there are many applications which cannot be virtualized by application level virtualization or which are required to be customized. For example, applications using windows service, kernel module or applications dependent on a particular element of OS. Such dependency of applications inevitably demands an application support list. Therefore, application level virtualization does not provide for the overall PC environment but merely allows a particular application to be used virtually.

OS Level Virtualization

Finally, the operating system level virtualization method is a method of virtualizing each constitutional element of an operating system (a processor, file system, network resource, system call interface, name space, and the like). Conventional operating system level virtualization methods have been developed mainly for the purpose of server virtualization, such as a Virtual Private Server (VPS). An operating system kernel in a server computer is partitioned and an independent OS environment is provided for each partition.

Conventional server hosting services provide one physical server for each user. This scheme can provide the user with a complete OS space. However, purchasing many real servers requires an initial investment as well as maintenance expenses.

The OS level virtualization makes it possible to create multiple independent virtual OS in a single real OS. A user is able to independently utilize needed environments in an OS. In addition, it is inexpensive since the user does not need to purchase another physical server.

Additionally, the OS level virtualization method has been used as a method for efficiently providing an independent OS space to a user who needs a multiple OS environment for the purpose of software development and testing.

### DISCLOSURE OF INVENTION

### Technical Problem

The present invention provides a new virtualization technique which makes it possible to move PC environments easily and quickly, to distribute software products, to share a physical PC with independency guaranteed, to initialize PC environments easily and conveniently and the like. The new virtualization should provide a computing environment, while not asking PC users to acquire additional knowledge about OS, installing and setting for a program and the like. It will allow the users to utilize the PC with the ease that they utilize other ordinary appliances.

For these purposes, the present invention provides a movable virtual machine image which is independent of the hardware, utilizes most of the OS environment of the PC, is easy to attach or detach from the OS, and presents easy and quick moving, distributing, sharing and initializing. In the present specifications, the term “movable” is used to describe the above-explained features.

Virtualization techniques are currently often used in the fields of server integration, software development and testing, and hosting. However, movable virtual machine image pursued in the present invention has not yet progressed. In addition, as is described above, all current conventional virtualization techniques are not adequate for the objective of the present invention.

In case of using hardware level virtualization, a single virtual machine requires the same memory and hard disk resources as the real machine. It is thus difficult to create multiple virtual machines in a single computer. However, OS level virtualization creates multiple virtual machines in a single computer, because each virtual machine does not require resources to operate its own OS. Therefore, compared with hardware level virtualization, OS level virtualization can operate multiple virtual machines with few resources.

In spite of the advantages of OS level virtualization, it has not been applied to the PC environment. This is because the ability to move a virtual image has not been realized as of yet.

The hardware level virtualization can guarantee the mobility of the virtual machine image, since it creates a virtual image as an independent system including an independent OS. However, OS level virtualization up to now merely splits the OS of the real machine and uses the split OS virtually. It is not able to detach the created virtual machine from the real machine and attach it to another real machine in the form of an image.

This is because dependent functions and resources exist to be shared with the real OS in an OS environment. Each user uses the OS with his preferable system setting, drive name, home directory path and authority and path for file and registry which are different from those of other users. The created virtual machine cannot be executed normally for these various environments.

If it is possible to create and utilize a virtual machine image that guarantees complete mobility while using the OS level virtualization, we will be able to receive all the benefits of the OS level virtualization. This makes it possible to move PC environments as quickly and efficiently as possible. The present invention provides a method for generating a movable virtual machine image using OS level virtualization.

### Technical Solution

The following is an explanation of the basic concept for OS level virtualization of the present invention.

Elements of OS

An OS includes Kernel, Device Driver, System Process, Service Process and the like.

The kernel is the core of the OS. It is the part of the OS that provides multiple basic services to other parts of the OS. The Kernel manages the hardware or resources of the system and abstractizes them.

Generally, a kernel includes Kernel Execution Part and HAL (Hardware Abstraction Layer).

Kernel Execution Part takes charge of process and thread management, memory management, object management, security management, inter-process communication management and the like.

HAL abstractizes the hardware to make it possible to use it without direct access to the hardware by other applications or elements of kernel.

The Device Driver is used to control physical devices, or to execute commands in the kernel level.

The System Process is a core process of the OS to be executed under the user mode and takes charge of device driver requests, user login/logoff, security and the like.

The Service (daemon) Process is a process that is executed in the background under the user mode and takes charge of all sorts of services such as file sharing service, telnet service, web service, printer service and the like. These kinds of services are executed in the background and supports applications or other elements of the OS in order for them to perform their part.

The application process is software, such as the word processor or the windows media player, to provide the user with the functions actually needed and executed in the OS. Generally, we call the OS and applications, software (software=operating system+application).

Layered Kernel Element

FIG. 1 shows a preferred embodiment according to the virtualization of the present invention.

An environment with an independent quest OS has virtual kernel, execution space and virtual machine data.

Table 1 shows the general structure of a PC including the OS.

Table 1

TABLE 1

| | |
|---|---|
| Elements of Application | Application |
| Elements of OS and Application | Service |
| Elements of OS | System Process |
| | Device Driver |
| | Kernel Execution Part |
| | HAL |
| Elements of Hardware | Hardware |

The elements of the OS, HAL, Kernl Execution Part, device driver, system process, service and the like are layered.

When an upper layer element requests a specific process from a lower layer element, the lower layer completes the process and then returns the result.

Virtualization, according to the present invention, can be attained by controlling the processing of the lower layer element upon the request from the upper layer element. For example, when the device driver requests the creation of an object from the kernel execution part, the corresponding object is created in a virtual space and the result is returned. When an application requests creation of c:\myfile.txt file, the kernel execution part creates it not in the real disk but in the virtual disk and then the result is returned.

The upper layer element processes all functions in response to the lower layer element. Consequently, the upper layer element can be operated in the virtual machine without any modification, provided that the lower layer element is virtualized.

Using the present invention, the lowest layer elements of the OS, HAL and Kernel execution part, are virtualized. Consequently, the upper layers, such as the device driver, the system process, the service process or applications, can be executed in virtual space without any modification.

The following is as explanation of the movable OS of the present invention.

Generation of Virtual Kernel

The kernel execution part layer can virtualize the kernel by dispatching the requests from the upper layer into the real space or one or more virtual spaces. A request for a thread or process that belongs to the real machine is dispatched to the real space and the request for a thread or process that belongs to the virtual machine is dispatched to the virtual space. Executing in the virtual machine means that a request to the kernel execution part is dispatched.

FIG. 3 shows that requests from an upper layer are dispatched to virtual space or real space through the kernel execution part.

The kernel execution part can be virtualized by means of the virtualization of the name spaces such as files, registries or objects, the virtualization of processes and threads, and the virtualization of memories.

The following will explain how to realize the virtualization for the name space.

The file, registry, kernel object and so on are the kernel elements that have names. For example, a file has a name such as \Device\HarddiskVolume1\myfile.txt, and a registry has a name such as \Registry\Machine\Software\mykey, a kernel object has a name such as \BaseNamedObjects\myobject.

These names are managed in the name space. When a specific kernel object is opened, the kernel execution part checks whether the corresponding object exists in the name space. When a specific kernel object is created, the kernel execution part, checks whether there are duplicated objects in the name space. If the kernel object is created, the object name is recorded in the name space. Each virtual machine has a unique name space. For example, in case of the virtual machine, VM1, the request for said file, \Device\HarddiskVolume1\myfile.txt is dispatched to \VM1\Device\HarddiskVolume1\myfile.txt. The request for said registry, registry \Registry\Machine\Software\mykey, is dispatched to \Registry\VM1\Machine\Software \mykey. The request for the object, \BaseNamedObjects\myobject, is dispatched to \VM1\BaseNamedObjects\myobject. As a matter of course, the name to be dispatched may conform to an optional rule. Thus, the virtualization for the name space is realized by bestowing an independent name space for each virtual machine.

The following will explain how to realize the virtualization for the process and the thread.

In regard to an OS, a thread is the minimal unit for execution and a process is a set of threads that shares a memory address. A request for generating a process or a thread is transferred to the kernel execution part. If a mother process that requests to generate a son process is within a particular virtual machine, the kernel execution part generates the son process within that particular virtual machine. If a process that requests the generation of a thread is within a particular virtual machine, the kernel execution part generates the thread within that particular virtual machine. Generally, these are enough for the virtualization of the process and the thread, because a process is the basic unit of OS level virtualization.

In the present invention, however, the minimal unit of virtualization is the thread, not process. This is because the virtual machine does not generate some OS processes but shares the processes of the real machine to embody an efficient OS level virtualization. In this case, regarding a single process, the specified thread should be executed in the real machine and the specified thread should also be executed in the specified virtual machine. If the kernel execution part is asked to generate a thread, and if the mother thread that asked for the generated thread is within the virtual machine, the generated thread is also executed in the virtual space.

Mapping of Virtual Machine Image

Even if different machines have the same kind of OS, they will have different user authority and system settings for each system. Therefore, in order to move a virtual machine image used in one virtual machine to another virtual machine, it is required that the virtual machine image be mapped. The mapping includes the mapping of authority, the mapping of environmental variables and their settings, resources shared between the virtual machine and the real machine and the like. There are two ways to achieve these mappings, one is converting the virtual machine image to conform to the real machine and the other is registering the setting of the specific image to the kernel execution part. Each or both of these two methods can be used.

Details of mapping of authority are explained below.

A multi-user OS provides an access control function for each user to give them the authority to use for each file, registry and device. Usually, a virtual machine image does not have authority information or the authority of the user at the time the image is generated. In case that such authority is not available to other OS, booting may be discontinued. Therefore, the authority mapping is indispensable for importing images.

When the virtual machine image is modified to the real machine, the authority settings for files, directories, registries and devices in the image are adapted to the values of the OS environment of the real machine or default values of the OS. As a matter of course, the authority mapping can be omitted in the case of files, directories, registries and devices that do not need the access control for use or do not cause problems even though the access control is not established.

According to the method of registering to kernel execution part, the corresponding account itself is registered in the virtual kernel execution part.

In regard to the mapping of environmental variables and configurations, the environmental variable and configuration for the real machine is recorded on the basis of the drive path of the real machine. The virtual disk drive name in which a virtual machine OS is installed may be different from the drive name of the physical disk in which a real OS is installed. Therefore, part of the environmental variable and configuration that need mapping should be newly mapped.

The following explains the mapping of shared resources.

Some elements of the OS, such as system process and service process, are shared between the real machine and the virtual machine. The resources used in those processes are also shared. While the resources allocated per thread are dealt with by thread level virtualization, the resources allocated per process need appropriate treatment depending on the current circumstances. In the case of Windows, the k ernel32.dll and the user32.dll files of Windows of the real machine and the virtual machine should be synchronized.

Generating Virtual Machine OS Images by the Stand Alone Method

The virtual machine image includes OS data files. Generally, the OS data take up hundreds of mega bytes. The present invention use OS level virtualization so that OS files are not distributed as contained in a virtual machine image, but created directly using the OS of the real machine. The virtual machine image to be distributed contains the minimum data required for creating an OS image such as a file list, registry list and values for setting. File and registry data can be copied from the OS of the real machine.

The data contained in the virtual machine image to be distributed, such as a file list, a registry list and values for OS configuration, include all or part of the list existing in a variety of versions of the same OS. For example, Windows includes a variety of versions such as window 2000, window XP and the window 2003. The virtual machine image may include files and registry lists used in all or some versions of windows.

In the image mapping stage, only items in the OS of the real machine among the list are recorded for use. Thereafter, file and registry data are copied from the OS of the real machine to the virtual machine image. The copying may be performed in the image mapping stage or performed when the files and registries are actually used in the virtual machine execution stage.

For compatibility with DOS, Windows supports both the short file name SFN and the long file name LFN. When a file is copied, the LFN is not changed. However, the SFN may be changed from the real OS to the generated virtual image. Therefore, the SFNs should be corrected by force to be equal after copying. The file name recorded at a registry should also be corrected.

Image Transmitting with Streaming

The size of a virtual machine image file is generally very large. A full image file may be downloaded or copied for use. However, if an image is transmitted through streaming, the virtual machine can be used immediately without waiting for the completion of the full image to be downloaded. Using the streaming method, image files are stored in streaming storage and only the required parts are downloaded or copied to the virtual machine for use. The streaming storage device may be in the form of a server such as a file server, a web server or a FTP server, or in a form of a movable storage device such as a USB drive or a CD/DVD ROM. A fixed storage device such as an ordinary hard disk is also available.

The disk image can be streamed as set forth below. If a process, a thread or an instruction within a device driver requests access to a particular file or directory, the virtual kernel execution part dispatches the request to a virtual disk. The virtual disk then calculates the position of the requested file or directory on the virtual disk and, using the result thereof, finds an offset in the disk image file. In response to the request for the offset and the length, the streaming image storage device transmits data equal to the length at the offset on the image file. The virtual disk continues executing using the transmitted data.

The streaming of the registry image can be achieved by the following procedure. When a process, a thread or an instruction in a device driver requests access to a registry key or a registry value, the virtual kernel execution part accesses the registry image file to respond to the request. At this time, the offset and length for accessing the registry image file are calculated and the request is transmitted to the streaming storage. The streaming storage processes data at the offset and the length indicated in the registry image file and returns results thereof. The virtual kernel execution part continues executions using the transmitted data.

Image Loading Through Virtual Disk

A virtual disk is a virtual device for emulating a real hard disk with software. One virtual machine is connected to one or more virtual image file and a specific sector of the virtual disk is connected to a specific position of an image file. Therefore, requests for reading and writing data for a specific sector of the virtual machine are emulated to reading and writing corresponding data at a specific position of the image file. Requests for controlling partitions and disks are treated in the same manner. Using a virtual disk improves the mobility of an image, because multiple files and directories in a virtual machine exist in the real machine in a form of one disk image file. Encryption of an image file improves security because other users need to know the password to use the virtual machine. Each disk is given a drive name according to OS. For example, disks of window OS are given drive names such as C: or D:. A virtual disk also has its own drive name. Though they have the same C: drive, the C: drive of the virtual machine indicates the virtual disk and the C: drive of the real machine indicates the physical disk.

In the present invention, the virtual machine disk image presents a light option for low capacity. Generally, OS requires storage space over a hundred mega bytes. A disk image may include all files. In order to guarantee efficient mobility, a vacant image or an image containing only a file list can be distributed and the contents of the files can be supplied from the OS of the real machine. In order to minimize collision with the real machine, the OS can be set as drive O: and the application program can be set as drive P: to manufacture and distribute virtual disk images.

Layered Virtual Machine Image

When the virtual machine image is provided with a layered structure, not with a single file, the required image file can be inserted during use of the virtual machine. If a problem occurs in the virtual machine, the image files with the problem only need to be replaced. This is the advantage of layered structure. The virtual machine image comprises an OS image layer, an application template image layer, a user data image layer and a temporary data image layer. The temporary data stored in the temporary data image layer are generated in the virtual machine execution and may be deleted when a problem has occurred in the virtual machine. The user data comprises all sorts of document files, user-signified files, software files and registries installed and generated by the user and stored in the user data image layer. The application template image is created through exporting the virtual machine image. This image is not changed during the execution of the virtual machine. The virtual OS template image includes files and registries of the virtual OS and is not changed during the execution of the virtual machine

As shown in FIG. 2, the virtual OS, application template, user data and temporary data are layered. For example, a file system stacks virtual OS files, application template files, user data files and temporary data files. When an application requests c:\myfile.txt, the file is looked up in the temporary data. If it does not exist in the temporary data, it is looked up in the user data. If it does not exist there, it is looked up in the application data. If it does not exist there, it is looked up in the virtual OS files. Looking up a registry is conducted in the same manner.

Booting of Virtual OS

A user has to boot OS in order to use it. The OS booting proceeds steps of initializing all devices, delayed updating, and executing system process, service process and OS applications. The virtual machine also boots the OS in the virtual machine in the same manner. In the case of OS level virtualization, each virtual machine steps the booting procedure. After the realization of reinforcement for the process, thread and name space in the kernel execution part layer, Booting can start by calling the booting start point of the corresponding OS from the virtual kernel. The booting start point is recalled within the virtual kernel proceeds to boot in the same manner as the booting process of OS. In booting of a virtual machine, initializing physical devices is omitted but initializing virtual devices is additionally required. The delayed updating means that a resource, such as a file or the like, cannot be deleted or updated if the resource is in use, and the resource is generally deleted or updated in the next booting process after the system is turned off. The virtual machine booting should also deal with the delayed updating within the virtual machine.

The system process is an essential for providing the OS environment, which is in charge of management of user account, logon processing, session management, service management. For example, the window OS of Microsoft, Inc. has system processes such as Isass.exe, winlogon.exe, smss.exe and the like. The service process such as DCOM/RPC service, printer spooler service and the like is executed in background to support functions of other applications.

The system process or the service process may execute all the processes within the virtual machine, or share the processes that are already being executed in the host OS or other virtual machines in order to utilize the overall system resources efficiently. In the case of the account management system process, if it is executed for each virtual machine, independent accounts are generated for each virtual machine. However, sharing the process of the host OS, each guest OS can share account information such as the ID and password of the host OS. To share the system process or the service process, the access for all the global objects existing in the process should be mapped into the objects of the shared process. In case of the printer spooler service process, there is a naming pipe for controlling printers. When the notepad process in the guest OS requests to print a document, it is tried to access the naming pipe of the spooler service in the guest OS. However, the request needs to be mapped into the spooler service of the host OS because there is no spooler service in the guest OS and that of the host OS is shared.

The user needs to shutdown OS for closing. The OS shutdown is generally split into application close, device driver close, service process close, system process close and the like. The virtual machine should also close the OS in the virtual machine. The shutdown of the virtual OS follows the shutdown of the real OS but does not turn off the real devices.

Use of Virtual OS

After booting a virtual machine, a user can use the virtual machine just as he would use a real OS. The virtual machine supports a switch mode display and a seamless mode display. On the switch mode, each virtual machine has an independent display. When the user on one virtual machine wants to access another virtual machine or the real machine, the switch mode requires him to switch the screen using a shortened key or a command in the menu. In the seamless mode, a program of the real machine and a program of the virtual machine can be displayed on a screen at the same time.

Exporting a Virtual Machine Image

A file operation performed in the virtual machine is stored in the virtual disk image and a registry operation performed in the virtual machine is stored in the virtual registry image. The mobility, distribution and sharing of the virtual machine image are attained by exporting image files. The simplest way of exporting is to simply copy the image file. The preferable way of exporting is reducing the size of the image file by decreasing any redundancy in the image file. The redundancy is unnecessary information that may include temporary files, authority information, unshared files and registries of OS elements. An even more preferable way is to package a virtual machine image for further efficient sharing. This is achieved by setting up authority regarding each file, directory, device and registry in an image file, adding license information for OS or installed applications, and adding information for available OS version and required libraries.

### Advantageous Effects

The present invention allows a PC environment to escape from the limitations of the physical hardware. It removes the restriction that a PC environment established on a physical PC cannot transfer from the physical PC to another device. Additionally, the present invention overcomes the limitation that the software should be only be used together with the hardware as an organic whole. Users can create their own unique movable PC software environment by attaching it to and detaching it from PC hardware, thereby the mobility is attainable.

With the present invention, a user who is not familiar with PCs needs no additional knowledge about how to install programs and how to set up configuration of programs. Once a program work environment is set optimally, it can be copied and utilized easily and quickly at all times. The present invention replaces the concepts of installing and uninstalling by the concepts of copying and deleting. Once the virtual machine image is created and stored, the image can be utilized easily and quickly using the image cache and movable drives or file storage server.

Even a professional PC user will be able to utilize PCs more efficiently because he can quickly copy and delete programs.

### BRIEF DESCRIPTION OF THE DRAWINGS

FIG. 1 is a view schematically showing the OS level virtualization according to a preferable embodiment of the present invention.

FIG. 2 is a view schematically showing the layered data according to a preferable embodiment of the present invention.

FIG. 3 is a view schematically showing the operation of the layered kernel according to a preferable embodiment of the present invention.

FIG. 4 is a view schematically showing the routine for executing the virtual machine image according to a preferable embodiment of the present invention.

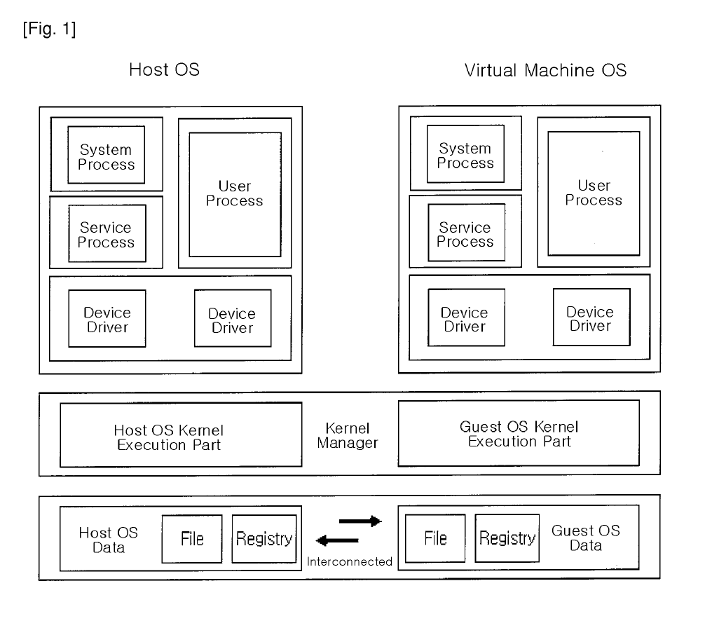

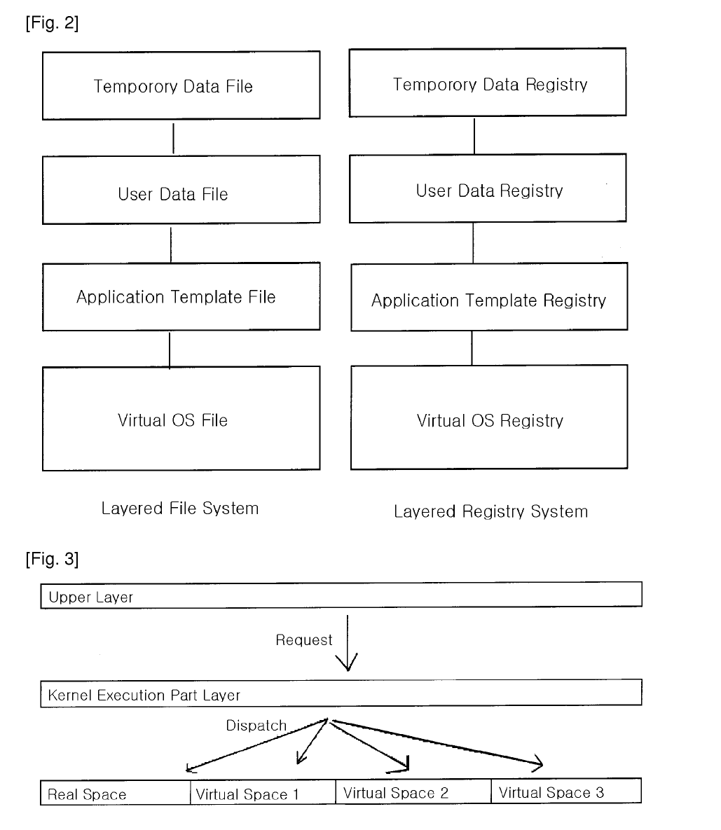

### BEST MODE FOR CARRYING OUT THE INVENTION

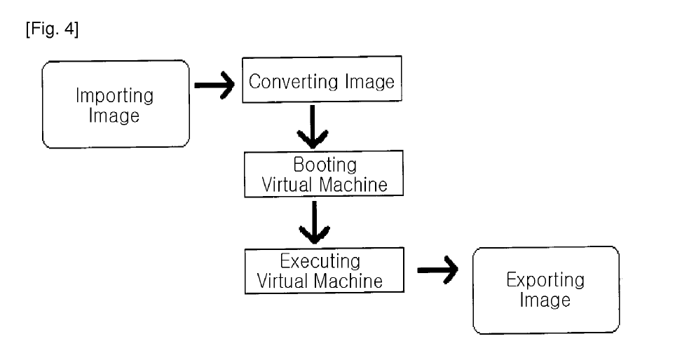

As shown in FIG. 4, the present invention performs the “basic routine” as set forth below.

1. To map a virtual machine template image including a first OS into a second OS of a real machine

2. To boot the virtual machine using the image.

The virtual machine template image is the image of the virtual OS divided by OS level virtualization, which may have only the OS, or may be an image imported from other PC.

In the booted virtual machine, the user can install programs and set required items to embody their own PC environment within the generated virtual machine. The booted virtual machine can be exported in the form of a virtual machine template image.

The exported image is stored first and always usable. The image can be moved to any other PC using a movable disk or by online transmission. The moved image can be exported to the other PC by executing the basic routine and then used as a new virtual machine. Thus, the mobility of PC environment is realized.

### Mode for the Invention

The present invention can provide a variety of conveniences for PC users.

The individual PC environment can be moved to other PCs at home, school, and office or somewhere in a foreign country, using a portable disk or via network.

Users who share a single PC may execute the basic routine to create and store a unique virtual machine image for each user. Whenever a user needs to use the PC, he executes the basic routine to access his virtual machine image. Thus sharing is realized.

It is also possible for a user to create multiple virtual machine images and utilize them according to their own purposes. For example, VM1 is used for secure electronic commercial transactions or Internet banking. VM2 is used for secure dealing with secret information of a company. VM3 is used for web surfing without security while the PC is exposed to danger of viruses or hacking.

A user who initializes a PC frequently needs to execute the basic routine to make an image set for his own initial PC environment. They must then export the image for saving. After doing this the first time, whenever he wants to initialize, he can import the image to execute the basic routine and thus the initialization is easily achieved. Even an ordinary person with little knowledge of PCs can resolve problems in his PC after learning how to execute the basic routine and how to import and export a virtual machine image. Their actions are easily done by only a couple of clicks of a mouse.

The present invention provides a new method for the distribution of software. A distributor of software may execute the basic routine using a virtual machine template image in which an OS is installed without any application. Then the distributor may sell a virtual machine image which is generated by exporting the virtual machine in which a product to be distributed has been installed. A consumer would purchase the image and only execute the basic routine in his PC to use the software immediately.

The consumer can order multiple software packages from the distributor by giving a written order that includes a list of software and configuration thereof. The distributor may create a virtual machine image according to the order and transmit it to the buyer. The distributor may prepare in advance various kinds of virtual machine images that are in the form of a package. The packages may include a bundle of frequently sold software.

Sales and distribution online is also possible. A server can be prepared to receive an order and create a virtual machine image in response to the order. The created image can be stored for reuse.

In a private or public enterprise, PC environments can be provided to members quickly. The manager executes the basic routine in a PC and installs all required software in the virtual machine. Then, he exports the image and keeps it stored. When a staff member needs the corresponding PC environment, the manager gives the image to the staff member and executes the basic routine in the staff member's PC. The business environment can be quickly prepared. An image may be created for each group according to their needs.

The present invention is also applicable for managers who are in charge of a large number of PCs, such as in Internet cafes or IT educational centers. A customer may use a PC through a virtual machine created by executing the basic routine with respect to the pre-stored image. In the case of a problem occurring in a PC, the PC may be immediately initialized using the original image. In addition, when a customer asks to use specific software, executing the basic routine for the virtual machine image in which the specific software is already installed can satisfy the customer's request.

Although the present invention has been described with reference to several preferred functions, the description is illustrative of the invention and is not to be construed as the limitation of the invention's ability. Various modifications and variations may occur to those skilled in the art, without departing from the scope of the invention as defined by the appended claims.

1. A method for operating a virtual machine template image as a virtual machine, the method comprising the steps of:
mapping a virtual machine template image to a host operating system to adaptively converting the virtual machine template image to a virtual machine image, and
booting an operating system of the virtual machine with operating system level virtualization using the adaptively converted virtual machine image.

2. The method according to claim 1, further comprising creating a virtual disk, wherein the adaptively converted virtual machine image is loaded to the virtual disk.

3. The method according to claim 1, wherein the mapping comprising at least one of authority mapping, environmental variable mapping, operating system configuration mapping, drive mapping and shared resource mapping.

4. The method according to claim 1, wherein the mapping comprising stand alone mapping, the stand alone mapping comprising the steps of:
selecting a list of operating system files and registries of a corresponding version of the host operating system among the lists of versions of the operating system files and registries provided in the virtual machine template image, and
copying data of operating system files and registries corresponding to the selected list from the host operating system to the virtual machine image.

5. The method according to claim 1, further comprising creating a new virtual machine template image using a virtual machine image in use.

6. The method according to claim 1, the adaptively converted virtual machine image comprising a layered combination of a virtual operating system image, an application template image, a user data image and/or a temporary data image.

7. The method according to claim 1, the booting comprising:
creating a virtual kernel in a kernel execution part, and
loading at least some of virtual device drivers, virtual services and virtual system processes.

8. The method according to claim 7, wherein at least some of virtual device drivers, virtual services and virtual system processes are shared with the host operating system and the remainders are not shared with the host operating system.

9. The method according to claim 7, wherein the creating a virtual kernel in the kernel execution part is performed at least by thread level virtualization.

10. A method for distributing software, wherein at least a server is provided for distributing software, the server being able to communicate with at least one client through computer network, the method executed by the server comprising:
receiving a request for distributing a software to the client,
generating a virtual machine template image for operating system level virtualization, the requested software being installed in the virtual machine template image, and
transmitting the created virtual machine template image to the client,
wherein the transmitted virtual machine template image is capable of being mapped to a host operating system of the client to generate an adaptively converted virtual machine image in the client, whereby the requested software is distributed to the client.

11. The method according to claim 10, wherein the request including predetermination for at least one or more programs to be installed, configuration of the programs and elements of each program.

12. The method according to claim 10, further comprising storing a copy of the virtual machine template image transmitted to the client on a server and/or an exterior storage area, whereby the virtual machine template image being capable of retransmitting to the client.

13. The method according to claim 10 wherein the virtual machine template image is transmitted by streaming from the server to the client.

14. A method for transmitting a virtual machine template image, wherein at least a server is provided for transmitting the virtual machine template image, the server being able to communicate with at least one client through a computer network, the method executed by the server comprising:
receiving configuration of computer environment requested by the client, the configuration including a list of software and/or configuration of an operating system,
generating a virtual machine template image for operating system level virtualization according to the received configuration of computer environment, and
transmitting the created virtual machine template image to the client,
wherein the transmitted virtual machine template image is capable of being mapped to a host operating system of the client to generate an adaptively converted virtual machine image in the client, whereby the adaptively converted virtual machine image in the client has the computer environment requested by the client.

15. A computer program product comprising program instructions stored on at least one computer readable storage medium, the program instructions when executed cause a computer to perform the method of claim 1.

16. A computer program product comprising program instructions stored on at least one computer readable storage medium, the program instructions when executed cause a server to perform the method of claim 10.

17. A computer program product comprising program instructions stored on at least one computer readable storage medium, the program instructions when executed cause a server to perform the method of claim 14.
